(19) United States
(12) Patent Application Publication
(10) Pub. No.: US 2006/0087144 A1
(43) Pub. Date: Apr. 27, 2006

(54) Front cowl and vehicle provided with the same

(75) Inventors: Kaoru Kamimura, Shizuoka (JP); Naoto Sunaguchi, Shizuoka (JP); Kiyotaka Uemura, Shizuoka (JP)

Correspondence Address: HOGAN & HARTSON L.L.P., 500 S. GRAND AVENUE, SUITE 1900, LOS ANGELES, CA, 90071-2611, US

(73) Assignee: YAMAHA HATSUDOKI KABUSHIKI KAISHA

(21) Appl. No.: 11/253,063

(22) Filed: Oct. 17, 2005

(30) Foreign Application Priority Data
Oct. 20, 2004 (JP) 2004-305073
Sep. 5, 2005 (JP) 2005-256198

(51) Int. Cl. B62J 17/00

(52) U.S. Cl. 296/78.1

(57) ABSTRACT

An object of the present invention is to provide a front cowl that exhibits a sufficient stiffness even in use for underbone type motorcycles, etc., and a vehicle provided with the front cowl. The front cowl is formed into a shape, in which it extends obliquely rearward with a center point as a front end. The front cowl is formed with a horn opening, lighting openings, and baffle openings. The openings are arranged to be radial round a central portion as viewed from the front. The front cowl is formed with an irregular shape, which is defined by crest lines and trough lines. The crest lines are arranged between the horn opening and the lighting openings. The trough lines and the crest lines are arranged between the lighting openings and the baffle openings.

### BACKGROUND OF THE INVENTION

1. Field of the Invention

The present invention relates to a front cowl and a vehicle provided with the same.

2. Description of Related Art

Conventionally, among scooter type motorcycles, etc., there is known a vehicle provided with a front cowl, on which openings for the provision of turn indicators are formed. For example, see Japanese Patent JP-A-5-162676).

The front cowl described in JP-A-5-162676 is longitudinal-shaped and openings for the provision of turn indicators are formed on both left and right sides of a substantially central position in a vertical direction.

Some motorcycles, such as underbone type motorcycles, are known apart from scooter type motorcycles. With underbone type motorcycles, a frame between a seat and a handle is low in height to enable a driver to easily straddle a vehicle. Generally, a front wheel in underbone type motorcycles is large as compared with that in scooter type motorcycles. Therefore, a front cowl in underbone type motorcycles is small in aspect ratio. On the other hand, a breadth of a vehicle is not greatly different between scooter type ones and underbone type ones, and turn indicators are not varied in size according to different vehicle types. Therefore, with underbone type motorcycles, a ratio of an opened area to a whole front cowl is large.

Also, for the purpose of cooling an engine or the like, a front cowl is in some cases provided with a baffle opening or openings, through which an air is taken in from the front. In the case where a baffle opening or openings are provided in addition to openings for turn indicators, however, a ratio of an opened area to a surface area of a front cowl becomes increasingly large.

Accordingly, in some instances, by decreasing an aspect ratio of a front cowl in scooter type motorcycles, there is a problem that a front cowl of a small aspect ratio used for underbone type motorcycles or the like is short in stiffness.

### SUMMARY OF THE INVENTION

The present invention has been thought of in view of the above problems and has as an object to provide a front cowl that exhibits a sufficient stiffness even in use for underbone type motorcycles, etc., and a vehicle provided with the front cowl.

A front cowl according to the present invention is a front cowl formed with at least a lighting opening and a baffle opening and mounted on a vehicle. The lighting opening and the baffle opening are arranged radially as viewed from the front. Ribs are formed at least partially on peripheral edges of the respective openings.

Since the front cowl is formed with a plurality of openings and the openings are arranged radially, a decrease of the front cowl in stiffness is restricted. Also, while peripheral edges of the respective openings are liable to be decreased in stiffness, ribs are formed at least partially on the peripheral edges, so that a decrease in stiffness is restricted. According to the synergistic effect of radial arrangement of the openings and the ribs, the front cowl is maintained high in stiffness.

The lighting opening and the baffle opening can be arranged radially in various configurations. A substantially central line of the lighting opening and a substantially central line of the baffle opening may be made radial as viewed from the front. In one aspect, the “substantially central line” includes a line that divides an opening into two parts in a substantially symmetrical shape. The line may comprise a straight line or a curved line. Also, the openings, as divided, are not necessarily of the same shape.

Alternatively, respective peripheral edges of the lighting opening and the baffle opening may be partially made radial as viewed from the front.

Also, the lighting opening and the baffle opening may be provided in left and right pair to be positioned on both sides of a vehicle central line, which is positioned centrally in a vehicle breadth direction as viewed from the front. The lighting opening and the baffle opening, respectively, may include a large width portion, which is increased in width as it goes outside from the vehicle central line. The lighting opening and the baffle opening, which are positioned on the same side relative to the vehicle central line, may be arranged to be separated from each other as they go outside from the vehicle central line.

As described above, the front cowl according to the invention can exhibit a sufficient stiffness even when a ratio of an opened area is large. Therefore, it is possible to exhibit a sufficient stiffness even in use for underbone type vehicles, etc., not to mention scooter type vehicles.

### BRIEF DESCRIPTION OF THE DRAWINGS

FIG. 1 is a side view showing a motorcycle according to an embodiment;

FIG. 2 is a front view showing the motorcycle according to the embodiment;

FIG. 3 is a perspective view showing a front portion of a vehicle cover;

FIG. 4 is a front view showing a front cowl;

FIG. 5 is a side view showing the front cowl;

FIG. 6 is an enlarged, cross sectional view showing a B region in FIG. 1; and

FIG. 7 is a front view showing a front cowl according to another embodiment.

### DETAILED DESCRIPTION OF THE INVENTION

An embodiment of the present invention will be described below with reference to the drawings. In addition, an arrow FWD in the drawings indicates a direction of traveling of a motorcycle according to the embodiment.

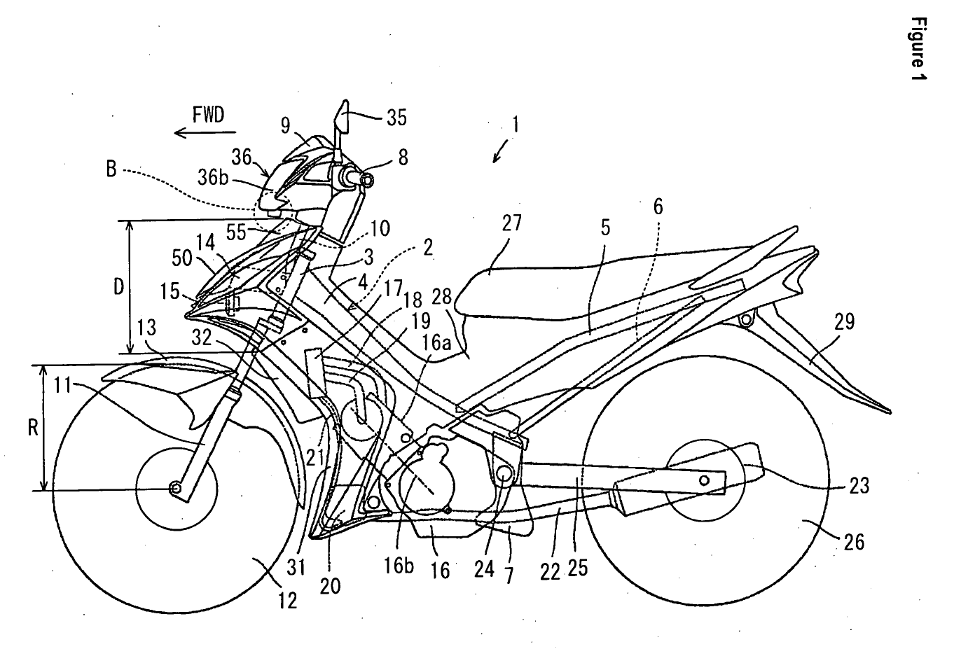

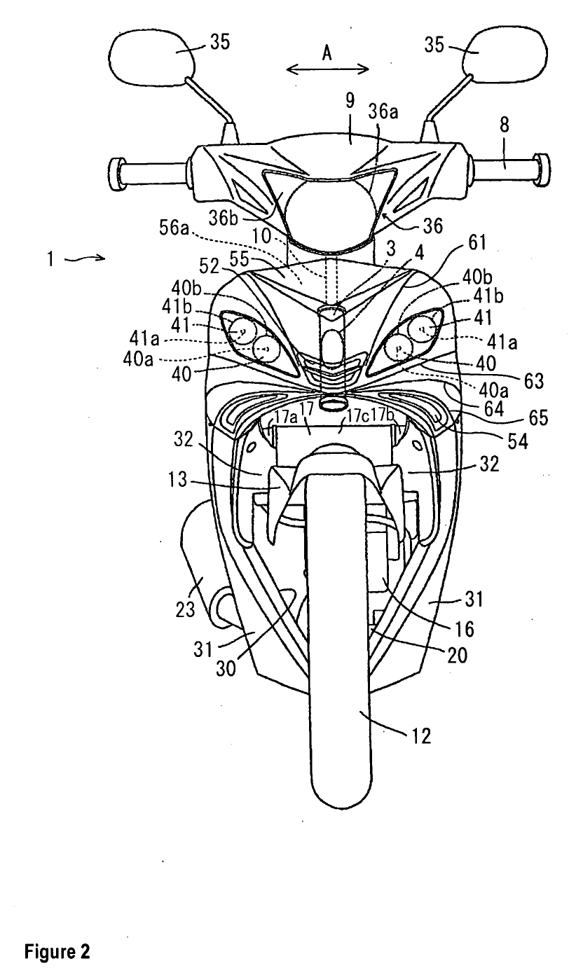

As shown in FIGS. 1 and 2, a saddle-ride type vehicle according to the embodiment comprises an underbone type motorcycle 1. In one aspect, to ensure stability in traveling on a rough road or the like, the underbone type motorcycle 1 uses wheels having a large diameter as compared with that of scooter type motorcycles. In addition, unlike sport type motorcycles, the underbone type motorcycle 1 includes a low frame (main frame) between a seat and a handle to, make a driver easy to straddle a vehicle body.

As shown in FIG. 1, motorcycle 1 comprises a vehicle frame 2 including a plurality of frame components. The vehicle frame 2 comprises a head pipe 3, a main frame 4 extending rearward and obliquely downward from the head pipe 3, a seat rail 5 extending rearward and obliquely upward from a rear portion of the main frame 4, and a back stay 6 bridging between a rear end of the main frame 4 and a rear end of the seat rail 5. A rear arm bracket 7 extending downward is fixed to an underside of the rear end of the main frame 4.

Provided above the head pipe 3 are a handle 8, and a cover member 9 that covers the handle 8. The cover member 9 is configured to turn integrally with the handle 8.

As shown in FIG. 2, back mirrors 35 are mounted on both left and right sides of the cover member 9. Also, mounted to a central portion of the cover member 9 is a headlight 36 including a bulb 36a and a headlight cover 36b that covers the bulb 36a.

As shown in FIG. 1, a pair of left and right front forks 11 are mounted to a lower portion of the head pipe 3. A front wheel 12 is mounted to lower ends of both front forks 11. As described above, the front wheel 12 has a large diameter as compared with that of front wheels of scooter type motorcycles. A front fender 13 is arranged above the front wheel 12.

A bracket 14 is mounted to a front side of the head pipe 3. Fixed to a lower portion of the bracket 14 is a horn 15 that emits an alarm sound forward. A front cowl 50 is mounted in front of the head pipe 3 and the bracket 14. The structure of the front cowl 50 will be described below. A harness 10 for electrical equipment or the like is arranged in front of the head pipe 3 and behind the front cowl 50. (See also FIG. 2). The harness 10 extends vertically along the head pipe 3 and rotates left and right together with the handle 8.

An engine 16 is arranged below the main frame 4. The engine 16 is mounted in a posture, in which an axis 16b of a cylinder 16a extends forward and obliquely upward. A radiator 17 that cools the engine 16 is provided forwardly and upwardly of the engine 16 and below the main frame 4.

As shown in FIG. 2, the radiator 17 includes a pair of tank portions 17a, 17b arranged at a predetermined interval therebetween in a breadth direction, such as an A direction as shown, of the motorcycle 1, and a core portion 17c arranged between the tank portions 17a, 17b. The core portion 17c is provided with a multiplicity of holes (not shown), through which a traveling wind passes.

As shown in FIG. 1, the radiator 17 and the engine 16 are connected to each other through a feed pipe 18 and a return pipe 19, which serve for circulation of cooling water. Also, a reservoir tank (recovery tank) 20 is arranged below a front portion of the engine 16. The reservoir tank 20 is connected to the radiator 17 through a feed and discharge pipe 21. In one aspect, the reservoir tank 20 functions to keep an amount of cooling water in the radiator 17 constant. An exhaust pipe 22 is connected to the engine 16. A muffler 23 is mounted to a rear end of the exhaust pipe 22.

A pivot shaft 24 is provided on the rear arm bracket 7. A front end of a rear arm 25 is supported on the pivot shaft 24 to freely swing vertically. A rear wheel 26 is mounted to a rear end of the rear arm 25.

A seat 27 is arranged above the seat rail 5. Also, a vehicle body cover 28 is mounted above the main frame 4, and the seat rail 5 extends from the front to the rear of the vehicle body. The vehicle body cover 28 covers the head pipe 3, the main frame 4, and the seat rail 5. Mounted rearwardly of the vehicle body cover 28 is a rear fender 29 that covers an upper portion of the rear wheel 26.

Also, arranged forwardly of the vehicle body cover 28 are a pair of left and right leg shields 31 that cover the front of the driver's legs. As shown in FIG. 2, an opening 30 is formed forwardly of the leg shields 31. The respective leg shields 31 are provided with baffle walls 32, which are made of a resin to conduct a traveling wind to the radiator 17. As shown in FIG. 1, front portions of the baffle walls 32 project forwardly of the leg shields 31.

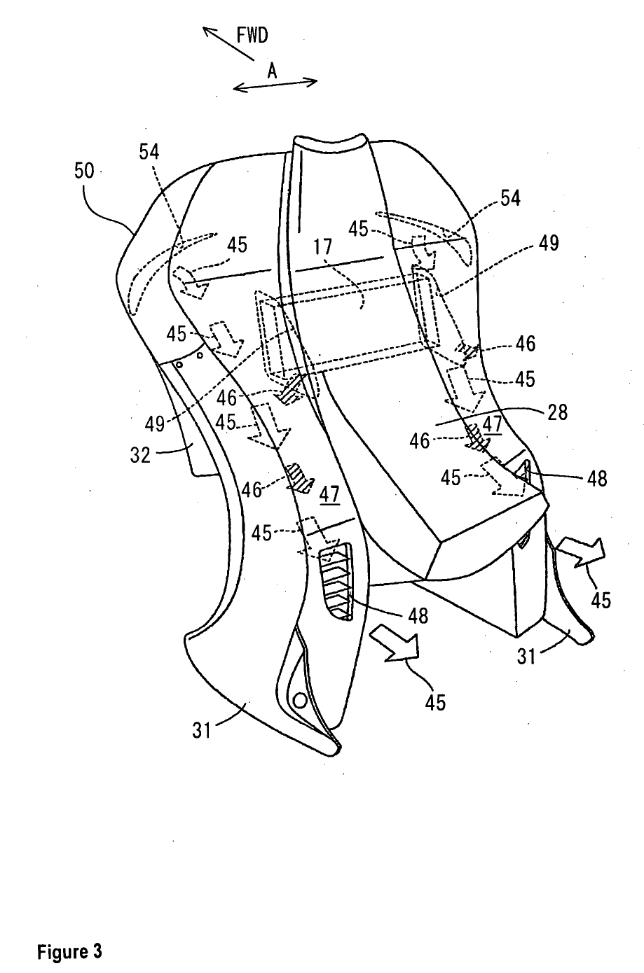

As shown in FIG. 3, the leg shields 31 are formed with baffle paths 47, along which a traveling wind is conducted. The baffle paths 47 serve as air passages, through which a traveling wind 46 having passed through the radiator 17 and a traveling wind 45 having passed through baffle openings 54 of the front cowl 50 are discharged outside the vehicle body. Provided rearwardly and obliquely downwardly of the baffle paths 47 are discharge ports 48 for discharge of the traveling wind 45 and the traveling wind 46. Also, formed midway the baffle paths 47 are openings 49 that conduct the traveling wind 46 having passed through the radiator 17 outside.

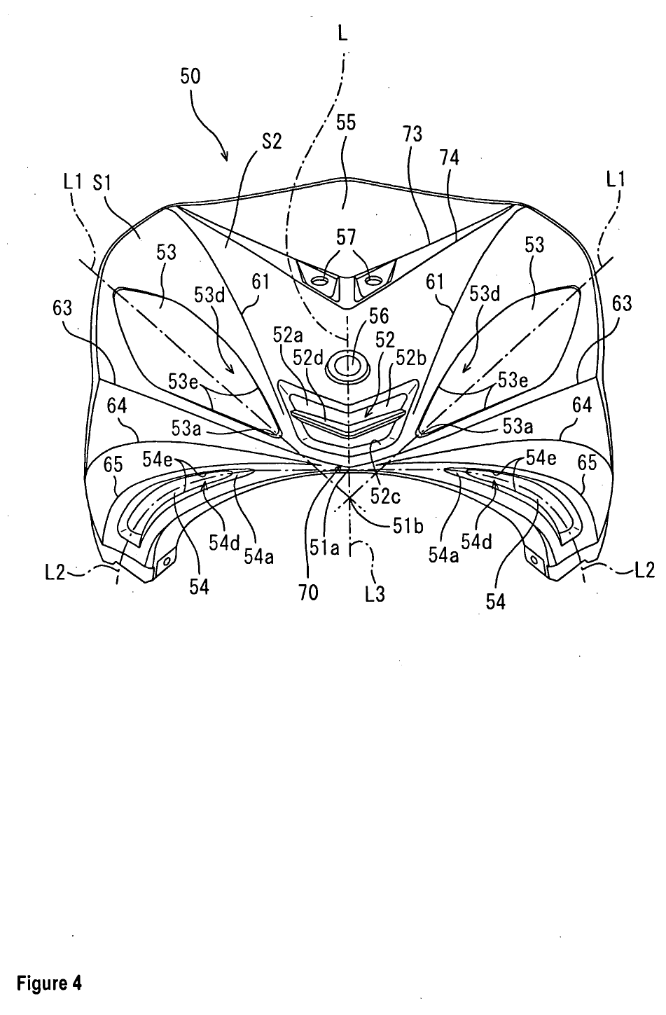

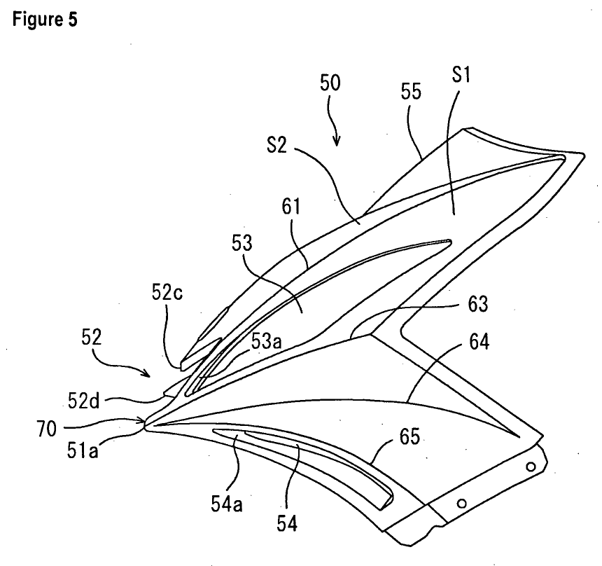

In addition, FIGS. 1 to 3 schematically show the front cowl 50 for the convenience of explanation. One embodiment of an actual shape of the front cowl 50 is shown in FIGS. 4 and 5.

The structure of the front cowl 50 will now be described in detail. In one aspect, “left and right” in the foregoing explanation left and right as viewed from a driver who straddles the vehicle body, but hereafter means left and right in the case, for example, where the front cowl 50 is seen from the front (vehicle front viewing).

As shown in FIG. 4, the front cowl 50 is formed to be left-right symmetric. The front cowl 50 in the embodiment is relatively small in aspect ratio (longitudinal length/transverse length), and the aspect ratio is about 1. Also, as shown in FIG. 1, a longitudinal length D of the front cowl 50 is substantially equal to a radius R of the front wheel 12 and at least smaller than a diameter of the front wheel 12.

As shown in FIGS. 4 and 5, the front cowl 50 comprises a thin-walled shell member to be formed three-dimensional to extend obliquely rearward with a center point 51a as a front end. In one aspect, the center point 51a referred to herein means a point making a center on a geometrical shape of the front cowl 50 and being positioned on a center line in a left and right direction and substantially centrally in a vertical direction. However, the center point 51a is not required to be physically point-shaped but may comprise a partial region of a surface. According to the embodiment, a region around points 51a, 51b, at which extensions of substantially central lines L1 of lighting openings 53 described later, substantially central lines L2 of the baffle openings 54, and a substantially central line L3 of a horn opening 52 intersect a central line L of the vehicle body in a breadth direction, is called a central portion 70 of the front cowl 50. In addition, the points of intersection may be positioned on the front cowl 50 as viewed from the front like the point 51a, or in locations offset from the front cowl 50 as viewed from the front like the point 51b.

Also, formed on the front cowl 50 are a plurality of crest lines and trough lines along directions extending outward from the central portion 70 as viewed from the front. More specifically, formed on the front cowl 50 are trough lines 64 extending left and right from the central portion 70, crest lines 61, 63 extending left and right and obliquely upward from the central portion 70, and crest lines 65 extending left and right and obliquely downward from the central portion 70.

Projections projecting outside are formed on the front cowl 50 at least by the crest lines 61, 63, 65. Also, recesses recessed toward the back side are formed by the trough lines 64. In this manner, the front cowl 50 is formed to be irregular-shaped along a periphery of the central portion 70. In other words, the front cowl 50 is formed with irregular portions, which comprise crest lines and trough lines. In addition, while not shown, gentle trough lines are formed outside the crest lines 61 in FIG. 4. As a result, a surface S2 bulges outside from a surface S1. See FIG. 5.

In addition, the trough lines 64 and the crest lines 61, 63, 65 comprise a line along a direction extending outward from the central portion 70 and are not necessarily needed to be connected to the central portion 70. That is, ends of the respective lines are not necessarily needed to be positioned in the central portion 70.

As shown in FIG. 4, the front cowl 50 is formed with a plurality of openings, which are arranged to be radial as viewed from the front. In addition, the term “radial” referred to herein simply means a state of extending outward from the central portion 70. Alternate long and short dash lines L1, L2, and L3 in FIG. 4 represent virtual lines extending radially from the central portion 70. Specifically, the front cowl 50 comprises the horn opening 52 arranged above the center point 51a and between the both left and right crest lines 61, the pair of left and right lighting openings 53 formed between the crest lines 61 and the crest lines 63, and the pair of left and right baffle openings 54 formed below the crest lines 65. The openings 52 to 54 are arranged round the center point 51a as viewed from the front and positioned in conformity to the irregular shape of the front cowl 50 so that a crest line or a trough line is positioned between adjacent openings.

More specifically, the lighting openings 53, the baffle openings 54, and the horn opening 52 are arranged in vehicle front viewing so that extensions of the substantially central lines L1 of the lighting openings 53, the substantially central lines L2 of the baffle openings 54, and the substantially central line L3 of the horn opening 52 are radial as viewed from the front. That is, the lighting openings 53, the baffle openings 54, and the horn opening 52 are arranged in vehicle front viewing so that as the substantially central lines L1 of the lighting openings 53, the substantially central lines L2 of the baffle openings 54, and the substantially central line L3 of the horn opening 52 go away from the central portion 70, they separate from one another. In one aspect, “substantially central line” means a line that divides an opening substantially symmetrically into two parts. Such line may be a straight line or a curved line. Also, openings divided into two parts not necessarily have the same shape.

Also, the lighting openings 53 and the baffle openings 54, respectively, comprise large width portions 53d, 54d increased in width as they go outward from the central line L of the vehicle body. The large width portions 53d, 54d, respectively, include peripheral edges 53e, 54e radially arranged in vehicle front viewing. That is, respective peripheral edges of the lighting openings 53 and the baffle openings 54 are partially radial in vehicle front viewing. In addition, according to the embodiment, the central line L of the vehicle body is in agreement with substantially central line L3 of the horn opening 52.

The horn opening 52 is positioned forwardly of the horn 15 (see FIG. 1) to serve as an opening to pass therethrough an alarm sound from the horn 15. The horn opening 52 comprises a left opening 52a extending leftwardly upward from a center thereof, and a right opening 52b extending rightwardly upward from the center thereof, these openings 52a, 53b being made contiguous together to form the horn opening.

A rib 52c is formed on a peripheral edge of the horn opening 52. The rib 52c is provided over a whole periphery of the horn opening 52. Also, a bar 52d extending in the left and right direction bridges centrally of the horn opening 52 in the vertical direction. In one aspect, the bar 52d is inclined forwardly downward to make it difficult to see the horn 15 from the front.

The lighting openings 53 are formed into a substantially elliptical shape to extend obliquely upward, and arranged radially round the central portion 70. Obliquely lower portions (portions toward the central portion 70) of the lighting openings 53 are formed to be tapered toward the central portion 70. The obliquely lower portions of the lighting openings 53 are provided on peripheral edges thereof with ribs 53a. Also, obliquely upper portions of the lighting openings 53 are also formed to be tapered.

As shown in FIG. 2, a position lamp 40 and a turn indicator 41 are arranged inside the lighting opening 53. The position lamp 40 and the turn indicator 41 are aligned in a lengthwise direction (oblique direction) of the lighting opening 53. The position lamps 40 are arranged obliquely below, and the turn indicator 41 is arranged obliquely above. That is, the turn indicators 41, respectively, are provided on the left inside the left lighting opening 53 and on the right inside the right lighting opening 53. The position lamps 40 comprise a bulb 40a and a reflection plate 40b that covers the rear of the bulb 40a. Also, the turn indicators 41 comprise a bulb 41a and a reflection plate 41b that covers the rear of the bulb 41a.

The baffle openings 54 serve as openings, through which a traveling wind is conducted, and are formed obliquely downward into a long shape. The baffle openings 54 are also formed radially round the central portion 70 and shaped to be tapered toward the central portion 70. The baffle openings 54 are provided on peripheral edges thereof with ribs 54a. As described above (see FIG. 3), the traveling wind 45 introduced into the baffle paths 47 through the baffle openings 54 joins a traveling wind 46 having cooled the radiator 17 and then is discharged rearward from the discharge ports 48.

As shown in FIG. 5, an upper portion of the front cowl 50 in a middle position in the left and right direction bulges outside to form a bulge portion 55. Accordingly, a surplus space 56a (see FIG. 2) is formed on the back side of the bulge portion 55. According to the embodiment, the harness 10 is accommodated in the surplus space 56a and interference between the front cowl 50 and the harness 10 is restricted.

As shown in FIG. 4, provided below the bulge portion 55 are a trough line 73 and a crest line 74, which extend in a V-shaped pattern as viewed from the front. That is, an irregular shape is formed below the bulge portion 55.

In addition, the front cowl 50 may be formed with other openings. For example, holes or the like for mount of a basket, etc. can be provided on the front cowl 50. Exemplarily, a hole 56 may be formed above the horn opening 52 and holes 57 may be formed between the trough line 73 and the crest line 74, as shown in FIG. 4. However, the holes 56, 57 are not necessarily needed.

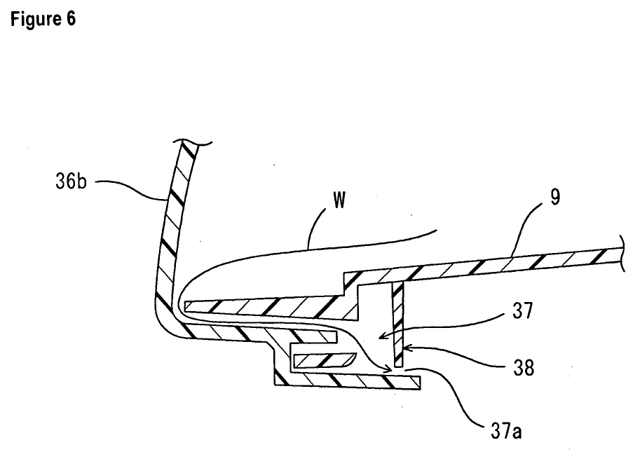

FIG. 6 is an enlarged, cross sectional view showing a B region in FIG. 1. As shown in FIG. 6, formed at a lower end of the headlight cover 36b is a drain hole 37, through which water W entering in the headlight cover 36b is discharged.

According to the embodiment, however, the front cowl 50 is arranged below the headlight cover 36b. The upper portion of the front cowl 50 is inclined rearward and obliquely upward, and in particular, the bulge portion 55 is positioned just below the headlight cover 36b. Therefore, there is a problem that an air having flowed rearward along surfaces of the front cowl 50 flows backward below the headlight cover 36b to flow into the drain hole 37. As a result, there is a problem that the water W is not smoothly discharged from the drain hole 37.

Hereupon, according to the embodiment, a rib 38 is provided rearwardly of the drain hole 37 to serve as a shielding member that allows the water W to flow out and blocks a counterflowing air. The rib 38 extends downward from a lower end of the cover member 9 to form a drain gap 37a between a tip end of the rib 38 and the headlight cover 36b. Accordingly, the rib 38 prevents a counterflowing air from flowing toward the headlight cover 36b. Therefore, the water W becomes easy to be discharged smoothly. Also, the rib 38 can prevent dust mixed in a counterflowing air from inflowing.

In addition, the rib 38 is in no way limited in shape and dimension. While the horizontal gap 37a in the example is formed between the tip end of the rib 38 and the headlight cover 36b, a vertical gap can also be formed by changing the position and shape of the rib 38. Also, the shielding member, which blocks a counterflowing air, is not limited to a rib shape but may be one having other shapes.

As described above, the horn opening 52, the lighting openings 53, and the baffle openings 54 are arranged radially, as viewed from the front, on the front cowl 50 according to the embodiment, so that although a ratio of the opened area to the whole front cowl 50 in area is large, it is possible to restrict a decrease in stiffness of the front cowl 50. Also, since the ribs 52c, 53a, 54a, respectively, are provided at least partially on the peripheral edges of the openings 52, 53, 54, it is possible to reinforce those peripheral portions of the openings, which are liable to be decreased in stiffness. Accordingly, the synergistic effect of arrangement of the openings 52, 53, 54 and the ribs 52c, 53a, 54a makes it possible to maintain the front cowl 50 high in stiffness.

Also, according to the embodiment, in a specific configuration of the radial arrangement of the lighting openings 53 and the baffle openings 54, the substantially central lines L1 of the lighting openings 53 and the substantially central lines L2 of the baffle openings 54 are made radial in vehicle front viewing. Also, in vehicle front viewing, the respective peripheral edges 53e, 54e of the lighting openings 53 and the baffle openings 54 are made partially radial in vehicle front viewing. Also, the lighting openings 53 and the baffle openings 54, respectively, include the large width portions 53d, 54d, which are increased in width as it goes outward from the central line L of the vehicle body, and the large width portions 53d, 54d include the peripheral edges 53e, 54e as radially arranged. Therefore, it becomes possible to maintain the front cowl 50 high in stiffness.

Also, according to the embodiment, the ribs 52c, 53a, 54a are certainly arranged on those sides thereof toward the central portion 70 (the center point 51a), in which a ratio of an opened area is increased as compared with that on outer sides thereof, so that an improvement in stiffness can be effectively achieved by efficiently arranging the ribs.

According to the embodiment, the horn opening 52 is arranged in the vicinity of the center point 51a where a decrease in stiffness is liable to occur. Since the rib 52c is provided on the periphery of the horn opening 52, however, it is possible to restrict a decrease in stiffness.

Also, according to the embodiment, the front cowl 50 is formed to extend obliquely rearward from the central portion 70. Therefore, the central portion 70 being central in the radial arrangement of the openings 52 to 54 is also a central portion of a three-dimensionally extending shape of the front cowl 50. Accordingly, stiffness is also maintained high.

The lighting openings 53 and the baffle openings 54 are formed to be tapered toward the central portion 70. Therefore, a ratio of an opened area of the front cowl 50 on a side toward the central portion 70 can be restricted to be small, thus enabling restricting a decrease in stiffness.

According to the embodiment, irregular portions defined by the crest lines 61 are provided between the horn opening 52 and the lighting openings 53 and irregular portions defined by the trough lines 64 and the crest lines 63, 65 are provided between the lighting openings 53 and the baffle openings 54, so that portions between those openings, which are liable to be decreased in stiffness, can be reinforced by the irregular portions on the surface.

Also, the trough lines 64 and the crest lines 61, 63, 65 are arranged radially round the central portion 70. Therefore, the trough lines 64 and the crest lines 61, 63, 65 are arranged densely on a side toward the central portion 70 where a decrease in stiffness is liable to occur, and arranged sparsely on an outward portion where stiffness is relatively high. Accordingly, stiffness can be appropriately increased according to a distance from the central portion 70.

By the way, since an outer side of the front cowl 50 is small in ratio of an opened area as compared with a central side thereof, it is essentially higher in stiffness than the central side. According to the embodiment, the turn indicators 41 are arranged outside in the lighting openings 53. That is, the turn indicators 41 are provided on opposite sides to the central portion 70. Therefore, since the turn indicators 41 are arranged on outer sides where stiffness is relatively high, it is possible to restrict a decrease of the front cowl 50 in stiffness even when the reflection plates 41b are enlarged. According to the embodiment, since the turn indicators 41 are arranged in positions above the position lamps 40 and further the reflection plates 41b can be enlarged, the turn indicators 41 can be improved in visibility.

According to the embodiment, the front cowl 50 is formed with the left baffle opening 54, which extends leftward and obliquely downward as viewed from the front, and the right baffle opening 54, which extends rightward and obliquely downward as viewed from the front. Since the baffle openings 54 extend obliquely downward, the traveling wind 45 drawn from the front can be easily conducted downward. Accordingly, the traveling wind 45 can be easily conducted through the baffle paths 47 of the leg shields 31 to positions keeping out of driver's knees.

With the motorcycle 1 according to the embodiment, the headlight 36 is provided on the cover member 9 on a side toward the handle 8. Accordingly, there is no need of providing any opening for the headlight 36 on the front cowl 50 and it is possible to correspondingly heighten the front cowl 50 in stiffness.

Also, according to the embodiment, interference between the front cowl 50 and the harness 10 can be restricted since the bulge portion 55 is provided above the central portion of the front cowl 50 in the left and right direction. That is, it is general in motorcycles or the like that the harness 10 is frequently provided on the back side of the front cowl 50 and in front of the head pipe 3. The front cowl 50 according to the embodiment is provided with the bulge portion 55 whereby a relatively large space is formed on the back side (in front of the head pipe 3) of the upper portion thereof. Accordingly, it is possible to restrict interference between the harness 10 and the front cowl 50. Also, according to the embodiment, irregular portions defined by the trough lines 73 and the crest lines 74 are provided below the bulge portion 55. Accordingly, it is possible to compensate for that decrease in stiffness, which is caused by the provision of the bulge portion 55.

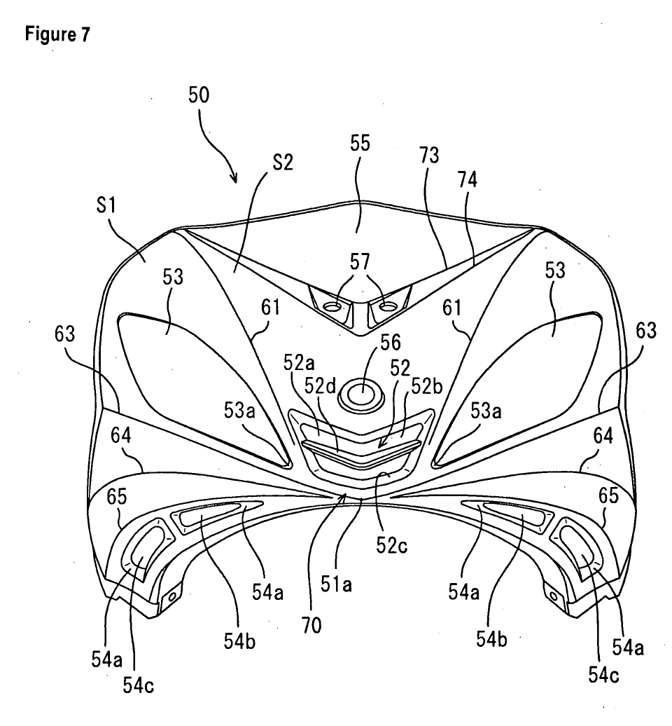

In addition, according to the embodiment, the left and right lighting openings 53 and the left and right baffle openings 54, respectively, are defined by a single opening. However, the left and right lighting openings or the left and right baffle openings may be defined by, for example, two or more openings, which are aligned outward from the central portion 70. For example, the left and right baffle openings 54 may be divided into a first opening 54b and a second opening 54c as shown in FIG. 7.

While according to the embodiment, the motorcycle 1 comprises an underbone type motorcycle, the front cowl 50 can of course be mounted to other types of motorcycles, such as, for example, scooter type motorcycles or the like. Also, the vehicle according to the invention is not limited to a motorcycle.

As described above, the invention is useful for front cowls used in motorcycles, etc. and vehicles such as motorcycles, etc.

1. A front cowl mounted on a vehicle, comprising:
a lighting opening and a baffle opening, wherein the lighting opening and the baffle opening are arranged radially as viewed from the front; and
ribs formed at least partially on peripheral edges of the respective openings.

2. The front cowl of claim 1, wherein a substantially central line of the lighting opening and a substantially central line of the baffle opening are made radial as viewed from the front.

3. The front cowl of claim 1, wherein respective peripheral edges of the lighting opening and the baffle opening are partially made radial as viewed from the front.

4. The front cowl of claim 1, wherein the lighting opening and the baffle opening are provided in left and right pair to be positioned on both sides of a vehicle central line, which is positioned centrally in a vehicle breadth direction as viewed from the front, and wherein the lighting opening and the baffle opening, respectively, include a large width portion, which is increased in width as it goes outside from the vehicle central line, and the lighting opening and the baffle opening, which are positioned on the same side relative to the vehicle central line, are arranged to be separated from each other as they go outside from the vehicle central line.

5. The front cowl of claim 1, further comprising a central portion positioned to a center thereof with respect to the lighting opening and the baffle opening as viewed from the front, the front cowl being formed to extend obliquely rearward from the central portion.

6. The front cowl of claim 1, further comprising a central portion positioned to a center thereof with respect to the lighting opening and the baffle opening as viewed from the front, and wherein the ribs are formed at least partially on sides of the respective openings toward the central portion.

7. The front cowl of claim 1, further comprising a central portion positioned to a center thereof with respect to the lighting opening and the baffle opening as viewed from the front, and wherein at least sides of the respective openings toward the central portion are formed to be tapered toward the central portion.

8. The front cowl of claim 1, further comprising an irregular portion provided between at least one set of adjacent openings out of the openings and including a crest line or a trough line along a direction, which extends outside from a central portion of the front cowl as viewed from the front.

9. The front cowl of claim 1, wherein a pair of left and right lighting openings are formed as the lighting opening, and wherein turn indicators, respectively, including a light source and a reflector covering the rear of the light source are provided on the left in the left lighting opening and on the right in the right lighting opening as viewed from the front.

10. The front cowl of claim 1, further comprising:
a pair of left and right lighting openings, respectively, formed as the lighting opening to extend leftward and obliquely upward and rightward and obliquely upward as viewed from the front;
a horn opening formed between lower ends of the left and right lighting openings; and
a rib provided on a peripheral edge of the horn opening.

11. The front cowl of claim 1, further comprising:
a pair of left and right lighting openings, respectively, formed as the lighting opening to extend leftward and obliquely upward and rightward and obliquely upward as viewed from the front;
a horn opening formed between lower ends of the pair of left and right lighting openings; and
an irregular portion provided between the respective lighting openings and the horn opening and including a crest line or a trough line along a direction, which extends outside from a central portion of the front cowl as viewed from the front.

12. The front cowl of claim 1, further comprising, as the baffle opening, a left baffle opening extending leftward and obliquely downward as viewed from the front and a right baffle opening extending rightward and obliquely downward as viewed from the front.

13. The front cowl of claim 1, mounted in a location separated from a headlight on the vehicle with the headlight.

14. The front cowl of claim 1, further comprising:
a bulge portion formed on an upper side of a central portion thereof in a left and right direction to bulge outside; and
an irregular portion formed at least partially on a periphery of the bulge portion.

15. A vehicle comprising a front cowl according to claim 1.
